(19) United States
(12) Patent Application Publication
(10) Pub. No.: US 2015/0091275 A1
(43) Pub. Date: Apr. 2, 2015

(54) Eclipse Smart Dolly

(71) Applicant: Aaron Jordan, Indianapolis, IN (US)

(72) Inventor: Aaron Jordan, Indianapolis, IN (US)

(21) Appl. No.: 14/042,492

(22) Filed: Sep. 30, 2013

(51) Int. Cl. B62B 1/12

(52) U.S. Cl. CPC B62B 1/125
USPC 280/659

(57) ABSTRACT

An adaptable dolly device is described which is configured adaptively adjust in length according to the size of the cargo at hand to be transported. The device is designed to reduce the overall time spent loading and unloading a truck when transporting goods by effectively combining the faculties of a short dolly and a tall dolly. The device is preferably equipped with hooks, configured to securely hold tethering equipment such as rubber bands, elastic bands, or rope.

### CONTINUITY

This application is a non-provisional application of provisional patent application No. 61,707,028 filed on Sep. 28, 2012, and priority is claimed thereto.

### FIELD OF THE PRESENT INVENTION

The present invention relates to logistics, and more specifically, the physical ground work of employing a cart or similarly wheeled device as a transport vehicle to transport goods efficiently from one location to another.

### BACKGROUND OF THE PRESENT INVENTION

Conventionally, it is known that dollies, carts, and other wheeled devices are commonly employed in order to easily and briefly transport goods from one location to another. Currently, there are two primary types of dollies on the market—a short level dolly and a tall dolly. For those that use these tools frequently or daily, it can quickly become a arduous and highly time consuming practice to transport, use, and store both dollies at all times, in order to ensure that the correct dolly is on hand for the item to be moved. Similarly, owners or users of this two-dolly system may not have an easily accessible place to store both dollies on the truck.

Frequently, rubber bands or similarly elastic bands have been employed in order to keep cargo securely on the dollies. Occasionally, during conventional use of one of the dollies, one of the elastic bands may not be readily accessible or on hand (such as in the pocket of the user), and as such, cargo may fall, be damaged, or spill.

Unfortunately, there is currently no means of concurrently providing both the short level dolly and the tall dolly in one device. Other dolly designs have employed various forms of extensions or modular enhancements, which generally still require for the user to carry additional tools to change out pieces of the dolly in order to adapt the dolly's size to the size of the goods to be transported. Forms such as these may also be structurally weakened, and unable to handle as much weight as conventional, non-modular dollies. As such, employing dollies such as these is not always practical. The two-dolly system remains the most common, but adds unnecessary work to the task at hand due to the additional demand to transport two dollies rather than one.

Thus, there is a need for a device capable of securely transporting cargo via a wheeled dolly that is adaptable in nature, such that additional tools are not required to shorten or lengthen a portion of the dolly. The device is preferably rated to handle a high weight capacity, which may vary according to the cost and construction of the device. The device also preferably provides a means for securely storing rubber bands or other elastic bands in an easily accessible location on the device.

### SUMMARY OF THE PRESENT INVENTION

The present invention is an adaptive dolly device, configured to combine the features of a short level dolly and a tall dolly in to one adjustable, easy-to-use and time-saving dolly. The present invention is designed to provide users with an easy and convenient way to solely employ one dolly for all of their moving or transport needs, as the present invention is configured to adjust to various heights as needed.

As such, the present invention prevents users from having to transport, use, and then store both a short level dolly and a tall dolly. This saves storage and transport space, as well as the user's time. Additionally, the present invention is equipped with a series of hooks, which are designed to hold rubber bands, elastic bands, or rope in a coiled or taught fashion. The bands or rope are conventionally employed in order to secure larger items to the dolly in order to ensure that they do not fall off of the dolly.

### BRIEF DESCRIPTION OF THE DRAWINGS

FIG. 1 depicts the present invention as viewed from the front.

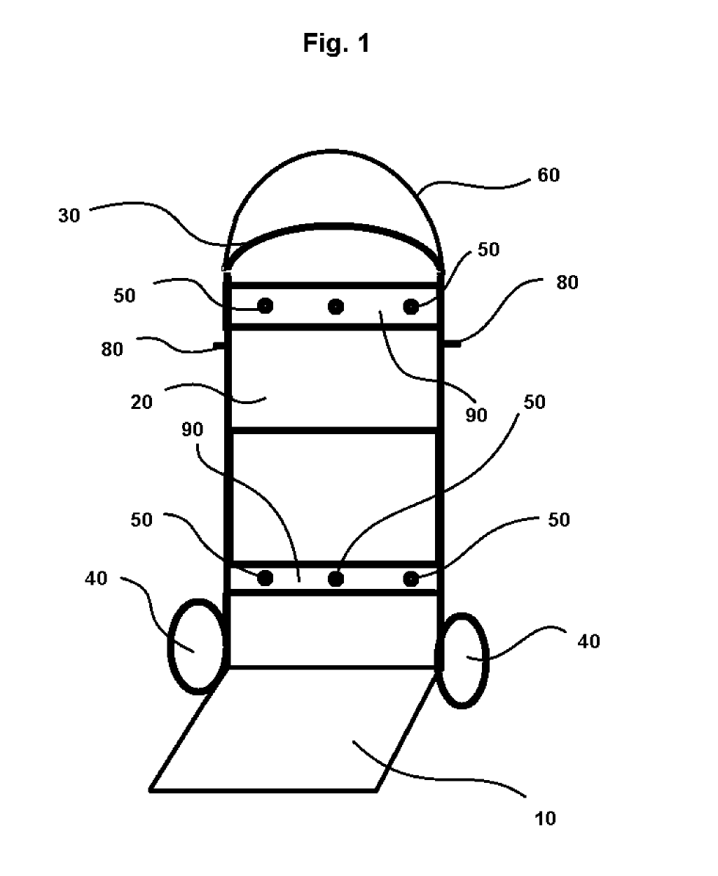

FIG. 2 shows the present invention as viewed from the side.

FIG. 3 exhibits a close-up view of the hooks of the present invention with rubber bands attached as viewed from the front.

### DETAILED DESCRIPTION OF THE PREFERRED EMBODIMENT

The present invention is an adjustable and adaptive dolly device configured to provide a stable framework for the transport of objects varying in size. The present invention facilitates the process of transporting goods conventionally employed when emptying or loading a truck with boxes or other items that vary in shape. Conventionally, dollies employ an L-shape design that creates a simple lever to lift goods via the wheel as a fulcrum. The present invention also employs this conventional design. The present invention has a horizontal platform (10) and a vertical portion (20), similar to that of conventional dollies.

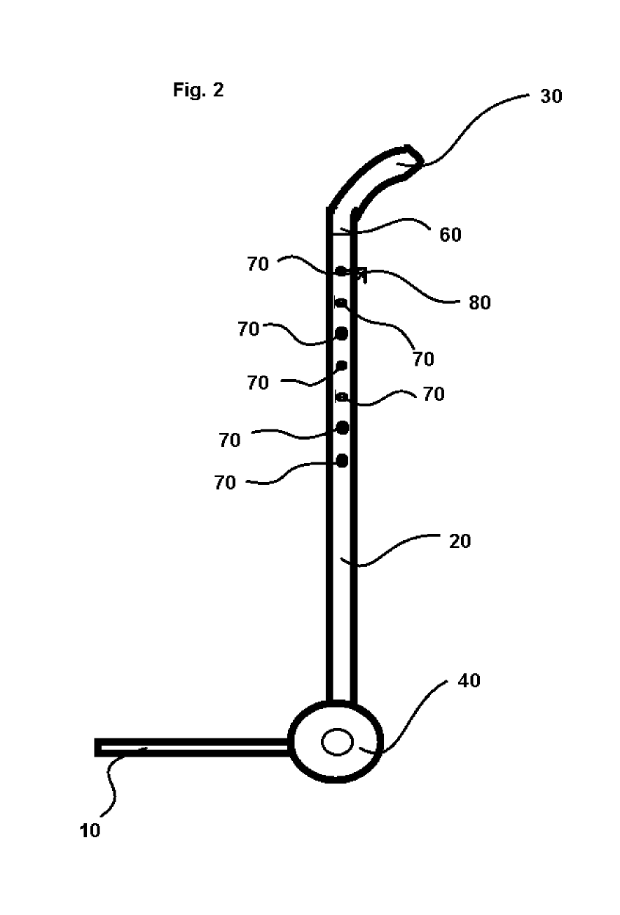

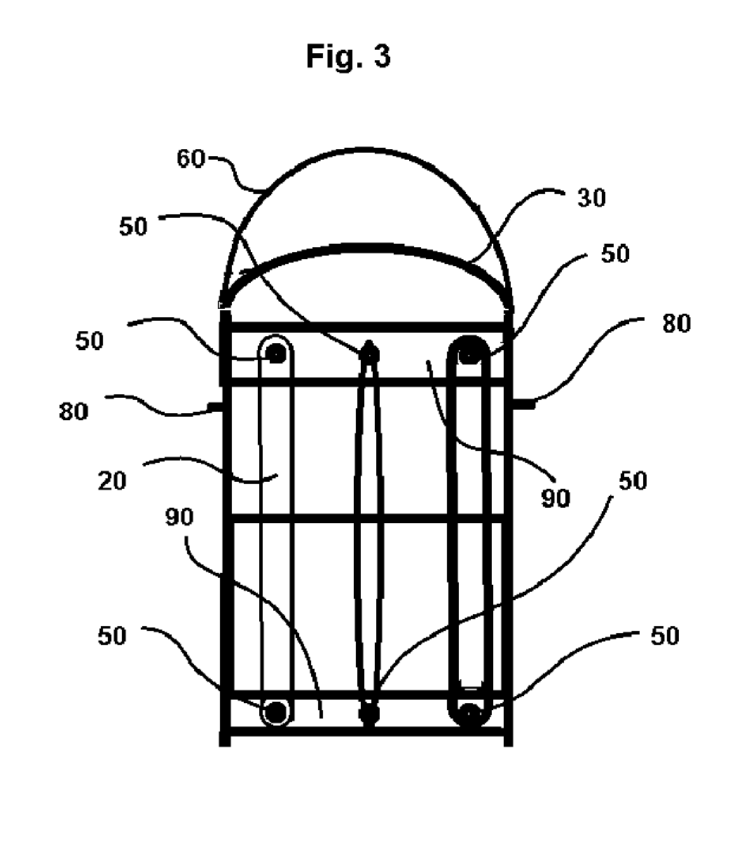

The present invention is preferably equipped with a handle (30), wheels (40), and hooks (50). The present invention primarily differs from other dollies in that the vertical portion (20) is designed to extend via an extender (60) which is in communication with the handle (30) and is primarily housed within the vertical portion (20), as seen in FIG. 2. A series of pinholes (70) are preferably arranged along the sides of both the vertical portion (20) and the extender (60). Pins (80) are preferably employed in order to secure the extender (60) in a desired position by placing the pins (80) into the pinholes (70) at the desired height. The pinholes (70) are preferably arranged approximately an inch apart, as seen in FIG. 3, such to provide a wide array of height options for the user in order to best adapt the present invention to the size of the goods to be transported.

As with other common dollies, the horizontal platform is configured to hold the goods securely, and to be pivoted when a downward or opposing force is applied to the handle (30). The weight of the goods is relayed to the wheels (40) of the present invention when in motion during transport. The pins (80) are configured to securely hold the extender (60) into a preferred position along the axis of the vertical portion (20). The pins (80) preferably provide little movement or leeway for the extender (60) to move or wiggle when the present invention is in motion and the handle (30) is pulled and pushed, providing locomotive force to the present invention.

The pins (80) are preferably composed of an impact resistant metal that is unlikely to fracture, snap, or break under pressure. The pins (80) may be bend or employ spring-loaded attachment to ensure that the pins (80) remain snugly within the pinholes (70) until removed by the user. When a user wishes to lengthen or shorten the vertical portion (20) containing the extender (60), the user first preferably removes the pins (80) from the pinholes (70). Next, the user determines at what height he or she wishes the extender (60) to extend out of the vertical portion (20). The user then manually moves the extender (60) up or down to the desired height, and then places the pins (80) into the appropriate pinhole (70).

It is envisioned that, in the preferred embodiment of the present invention, the extender (60) may be raised along the vertical portion (20) to a height of approximately 48 inches. However, it is envisioned that alternate embodiments of the present invention may have shorter or taller specifications depending on the overall size of the device.

Additionally, the preferred embodiment of the present invention is equipped with hooks (50) which are preferably placed in the center of the present invention in vertical lines consisting of two hooks (50) per vertical line as seen in FIG. 3. The hooks (50) are preferably configured to securely hold a series of rubber bands, elastic bands, rope, or other tethering vehicle when not in use. The bands or rope are conventionally employed on dollies in order to securely affix larger or awkward items to the device to ensure sound and damage-free transport. The exact specifications of the size and placement of the hooks (50) may vary upon manufacturing. The hooks (50) are preferably placed on horizontal bars (90) between the two vertical poles constituting the vertical portion (20) of the present invention.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

1. An adjustable dolly device comprising:
a vertical portion;
a horizontal portion extending perpendicularly from an end of said vertical portion;
two wheels;
wherein said vertical portion and said horizontal portion are disposed at a 90 degree angle at the center of said two wheels;
an extender, said extender being U-shaped;
wherein said extender is configured to slide within said vertical portion to extend the effective length of said vertical portion;
a series of pinholes disposed along sides of said vertical portion and sides of said extender;
a series of pins configured to fit in said series of pinholes; and
wherein said series of pinholes is configured to hold said extender in a fixed position relative to said vertical portion.

2. The adjustable dolly device of claim 1, further comprising:
two horizontal bars disposed between sides of said vertical portion, one of said two horizontal bars located toward the top of said vertical portion and a second of said two horizontal bars located toward the bottom of said vertical portion;
a series of hooks disposed along said two horizontal bars configured to hold bands between said two horizontal bars completely above said two wheels and said horizontal portion; and
a curved handle disposed atop said extender, said curved handle curving behind and away from said extender in a wide curvature.

3-4. (canceled)
